(19) United States
(12) Patent Application Publication
(10) Pub. No.: US 2005/0038639 A1
(43) Pub. Date: Feb. 17, 2005

(54) Multiple variable monte carlo simulation

(75) Inventor: Yiqun Lin, Melbourne, FL (US)

Correspondence Address: Fogg and Associates, LLC, P.O. Box 581339, Minneapolis, MN, 55458-1339, US

(73) Assignee: INTERSIL AMERICAS INC.

(21) Appl. No.: 10/641,698

(22) Filed: Aug. 15, 2003

(51) Int. Cl. G06F 17/50

(52) U.S. Cl. 703/14

(57) ABSTRACT

A circuit simulation and analysis tool for analyzing circuit parameters. In one embodiment, a method of evaluating circuit parameters of an integrated circuit design is disclosed. The method comprises defining two or more variables to apply to the circuit parameters and running a simulation with the two or more variables on the circuit parameters.

### TECHNICAL FIELD

The present invention relates generally to circuit simulations and in particular to a circuit simulation and analysis tool for analyzing circuit parameters.

### BACKGROUND

Computer design simulation programs to aid in the design of circuits in the electronic design automation (EDA) industry. One type of a computer design simulation program used in the design of integrated circuits is a Monte Carlo simulation. A Monte Carlo simulation uses random numbers and probability statistics to obtain approximate results. A specific area where Monte Carlo simulations have been employed is as a design simulation tool to evaluate parameters of a given design under a select condition or control variable. By employing a Monte Carlo simulation, a designer can determine if a parameter of a design will meet the requirements of the application. Although, current Monte Carlo simulations are helpful in evaluating some circuit parameters, current Monte Carlo simulations are not adequate to evaluate other parameters that require various conditions with multiple control variables.

For the reasons stated above and for other reasons stated below which will become apparent to those skilled in the art upon reading and understanding the present specification, there is a need in the art for an improved Monte Carlo simulation tool for the analysis of the design of integrated circuits.

### SUMMARY

The above-mentioned problems and other problems are resolved by the present invention and will be understood by reading and studying the following specification.

In one embodiment, a method of evaluating circuit parameters of an integrated circuit design is disclosed. The method comprises defining two or more variables to apply to the circuit parameters and running a simulation with the two or more variables on the circuit parameters.

In another embodiment, another method of evaluating circuit parameters in an integrated circuit design is disclosed. The method comprises defining a design variable to sweep. Running a simulation, wherein the simulation uses random numbers and probability statistics to obtain approximate results and building expressions to calculate circuit performance after running the simulation, wherein the errors in the expressions can be corrected without having to run another simulation.

In further another embodiment, a computer-readable medium including instructions for simulating parameters in a circuit design is disclosed. The computer-readable instructions include defining two or more variables to apply to the circuit parameters and running a simulation with the two or more variables on the circuit parameters.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is a flow chart illustrating the process of one embodiment of the present invention;

FIG. 2 is a graphics user interface (GUI) used to enter variables in one embodiment of the present invention;

FIG. 3, is a calculator GUI of one embodiment of the present invention;

FIG. 4, is a parametric Monte Carlo histogram GUI of one embodiment of the present invention;

FIG. 5, is a fast track filter GUI of one embodiment of the present invention;

FIG. 6A is another embodiment of a fast track results filter GUI of one embodiment of the present invention;

FIG. 6B is a histogram illustrating the simulation results of the fast track results filter GUI of FIG. 6A;

FIG. 7A is another example of a fast track results filter GUI of one embodiment of the present invention;

FIG. 7B is a histogram illustrating the simulation results of the fast track results filter GUI of FIG. 7A;

FIG. 8A is still further an example of a fast rack results filter GUI of one embodiment of the present invention;

FIG. 8B is a histogram plot illustrating the simulation results of the fast track results filter GUI of FIG. 8A; and

FIG. 9 is a plot of a family of cures illustrating the simulation results of the fast track results filter of GUI of FIG. 8A.

In accordance with common practice, the various described features are not drawn to scale but are drawn to emphasize specific features relevant to the present invention. Reference characters denote like elements throughout Figures and text.

### DETAILED DESCRIPTION

In the following detailed description of the preferred embodiments, reference is made to the accompanying drawings, which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide a multiple variable Monte Carlo simulation that evaluates circuit parameters with various conditions or multiple variables. Other embodiments allow for certain simulation to be skipped if desired. Further embodiments convert multi-dimensional data into a histogram. Moreover, the present invention provides new capabilities, improved simulation control and improved simulation data processing.

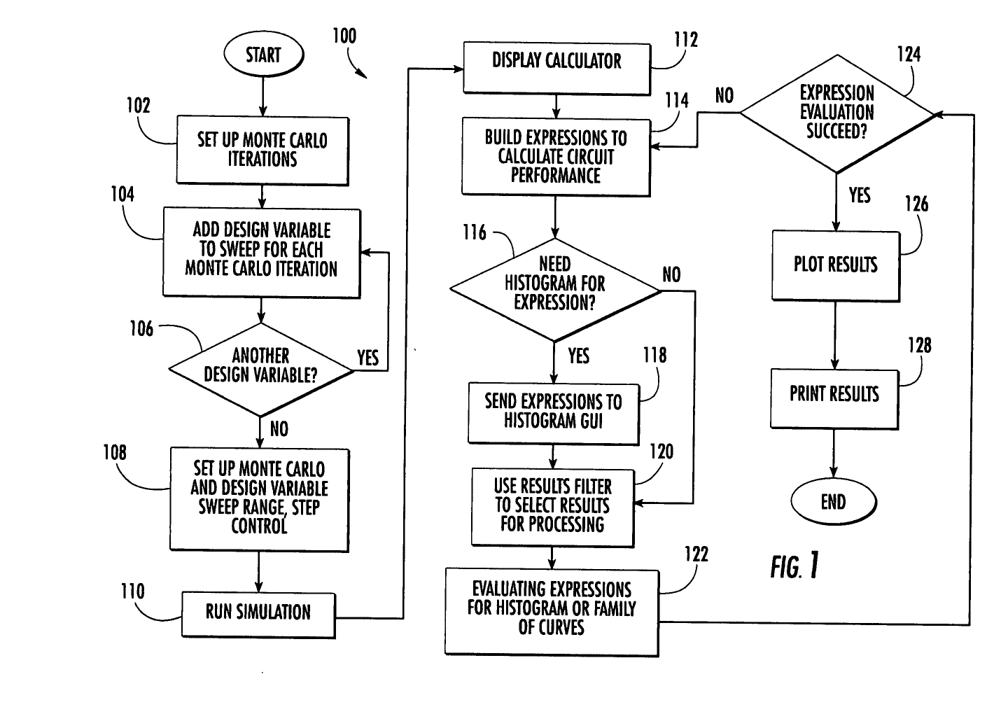

FIG. 1, illustrates a flow chart 100 of one embodiment of the present invention. As illustrated, flow chart 100 starts by setting up Monte Carlo iterations (102). Each iteration is a specific Monte Carlo run that corresponds to a set of statistically varied process and model parameters. During each Monte Carlo iteration process variation and mismatch parameters are generated for device models. A design variable is added to sweep for each Monte Carlo iteration (104). It is then determined if another design variable is desired (106). If another design variable is desired (106), another design variable is added (104). This embodiment allows for multiple design variables to be added one by one for multiple variable Monte Carlo analysis. Multiple variable sweeps are needed with some circuit parameters to extract various desired operating conditions. Once the desired amount of design variables are selected, a Monte Carlo and design variable sweep plan is set up (108). For example a range and step control is set. The step control is used to control the total number of steps or step size for a variable within sweep range. Certain simulations can be skipped by using the step control if desired. The simulation is then launched (110) after the sweep variables are setup. After the simulation has finished (110), a calculator tool is displayed (112). The calculator tool is used by designers to build expressions (or equations) that are used to measure circuit performance parameters (114).

Pursuant to flow chart 100, it is then determined if a histogram expression is needed (116). If one is needed (116), the expression is sent to a histogram GUI (118). Then a results filter is used to select results for processing (120). If a histogram for expression is not needed (116), the process then goes directly to using the results filter to select results for processing (120). Expressions are evaluated for histogram and family of curves plot/print (122). The expressions are evaluated (124). If the expressions are without errors (124), the results are plotted (126) and printed (128). However, if there are errors in the expressions (124), the expressions are corrected at step 114.

As illustrated in flow chart 100, embodiments of the present invention allow designers to build expressions to calculate circuit performance histograms after the simulation is launched. With this embodiment, if errors are found in the expressions they can be corrected without having to run another simulation.

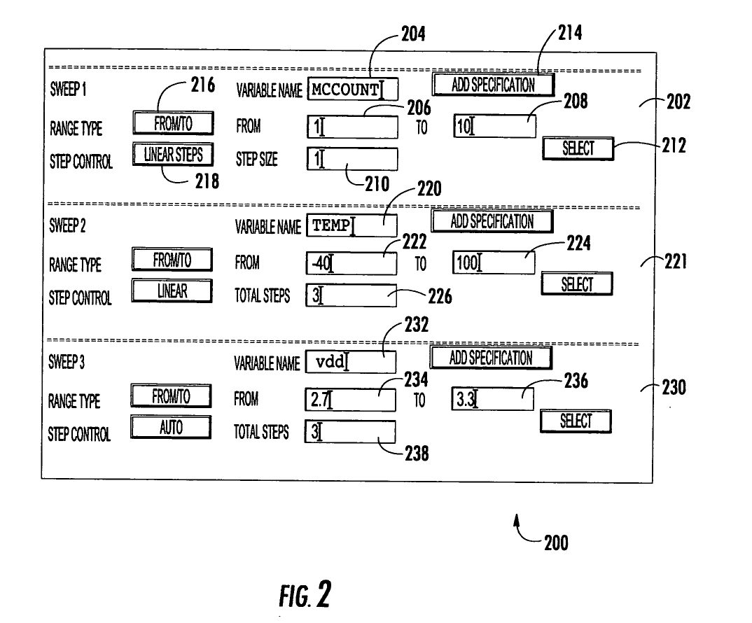

Referring to FIG. 2, a graphic user interface (GUI) 200 used to enter variables (conditions) of one embodiment of the present invention is illustrated. The GUI 200 embodiment of FIG. 2 includes three sweeps 202, 221 and 230 to perform three different sweeps with each sweep having a different variable to evaluate select circuit parameters. It will be understood in the art that number of sweeps can vary with the number of variables applied and that the present application is not limited to three sweeps. Variable of Sweep 1 (202) is a MCCOUNT variable. The MCCOUNT variable represents the number of Monte Carlo iterations to run. For example the Monte Carlo iterations may run from 1 to 10 with linear step sizes of 1 (i.e. in this example the iterations runs from 1, 2, 3 . . . to 10). As illustrated, each sweep has a variable name input 204, range type input 216, step control input 218, range inputs 206 and 208, step size input 210, an add specification activation button 214 and a select activation button 212. The range type input 216 defines a start and stop value for a sweep. The step control input 218 defines a list of values between the start and stop value in which the simulation runs at. The add specification activation button 214 allows certain points to be included in or excluded from the simulation. Sweep 2 (221) of this embodiment is a sweep for a temperature variable. As illustrated, sweep 2 (221) includes a variable name input 220, temperature range inputs 222 and 224 and the number of steps input 226. Sweep 3 (230) of this embodiment is a voltage variable. As illustrated, sweep 3 (230) includes a variable name input 230, voltage range inputs 234 and 236 and the number of steps input 238.

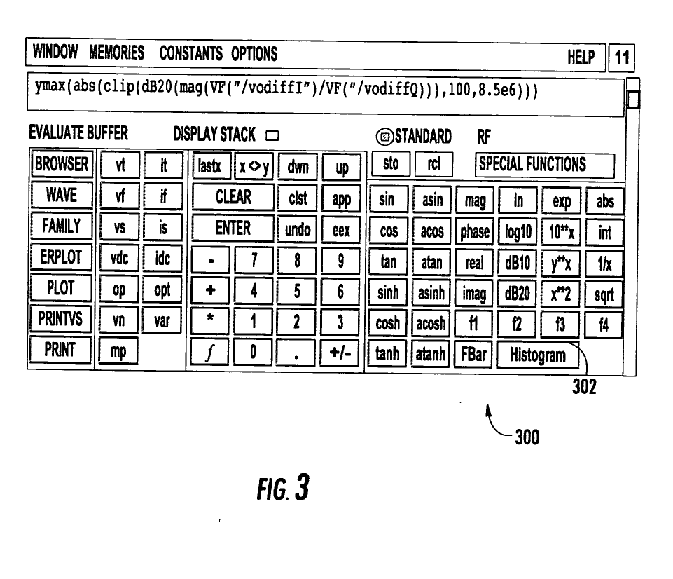

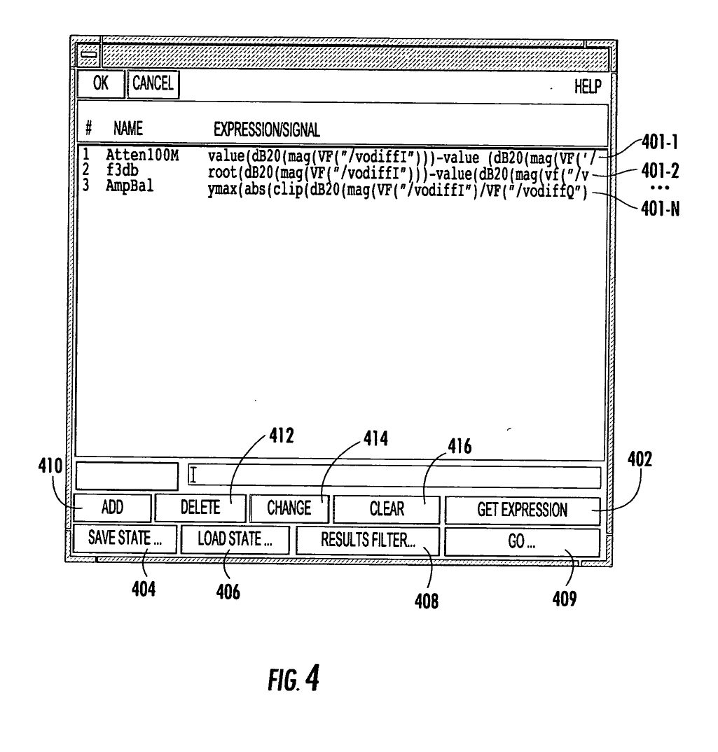

FIG. 3 illustrates a calculator GUI 300 of one embodiment of the present invention. The calculator GUI 300 allows a designer to build expressions (or equations) used to measure circuit performance parameters from data generated by the simulation. The calculator GUI 300 of this embodiment includes a histogram activation button 302. When selected, the histogram activation button 302 brings up a “parametric Monte Carlo histogram” form. An example of a parametric Monte Carlo histogram GUI form 400 of one embodiment of the present invention is illustrated in FIG. 4. As illustrated, GUI form 400 allows the designer to build calculator equations 401-(1-N). The equations 410-(1-N) are brought into the form 400 with the get expression 402 activation bar. Equations 410-(1-N) are manipulated by the add 410, delete 412, change 414 and clear 416 activation buttons (or activation bars). GUI form 400 also includes a save state button 404 to save the equations and a load state button 406 to load the equation setup. The result filter button 408 is used to bring the results filter form to selectively pick the data for processing. The go button 409 in the parametric Monte Carlo histogram GUI 400 is used to evaluate the equations and start the histogram plot. In one embodiment of the present invention, a design session can be closed without deleting the parametric Monte Carlo simulation results. In this embodiment, you can use the calculator histogram and results filter to plot/print the results even if the design session has been closed or has crashed.

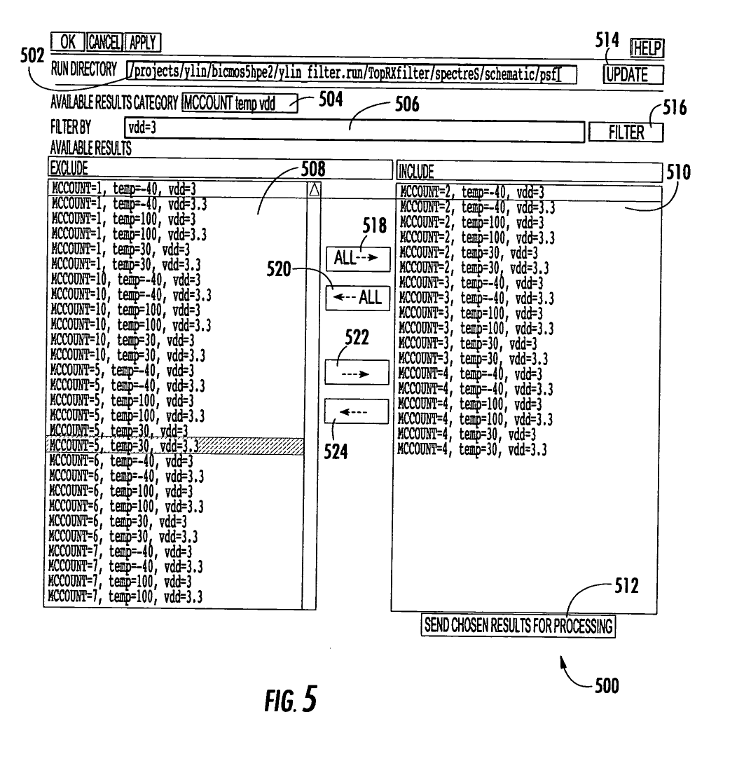

Referring to FIG. 5, a fast track results filer GUI 500 of one embodiment of the present invention is illustrated. The results filter GUI 500 comes up when the results filter button 408 is activated in the parametric Monte Carlo histogram 400. As illustrated, the results filter GUI 500 includes a run directory 502. In one embodiment, the run directory 502 is where the simulation data is stored. Also illustrated is the update button 514. Activation of the update button 514 finds all available parametric analysis and nominal simulation data in a run directory and then sends the results to the available results category 504 in a categorized format. The available results category 504 displays the available simulation result categories for a designer to choose for plot/print. In this embodiment, the categories are identified by the name of the parametric analysis sweep variables. When a parametric analysis category is selected, all related results will be displayed in the available results—exclude field 508 to allow the designer to do further operations. If a normal simulation result is selected, nothing will be displayed in the available result fields (i.e. the exclude filed 508 or the include filed 510).

The filter by field 506 of FIG. 5, allows for variables and values for parametric analysis results filtering. For example, if there is a parametric analysis with five sweep variables V1, V2, V3, V4 and V5 and you are only interested in results where V1=A and V4=B you can type this standard into the “filter by” field 506 for results filtering for plot/print. Activation of the “filter” button 516 filters based on the standard in the filter by field 506. The results are passed on to the available results exclude field 508 for further operation. The exclude field 506 displays all results that will be excluded for plot/print. The include field 510 displays all results that will be included for plot/print. The all -->button 518 moves all results to the include field 510. The <-- all button 520 moves all results to the exclude field 508. The -->button 522 moves all selected results from the exclude field 508 to the include field 510. The <-- button 524 moves all selected results form the include field 510 to the exclude field 508. When the send chosen results for processing button 512 is activated, the run object file will be regenerated to organize the results. Moreover the send chosen results for processing button 512 loads the selected results and activates any related menus for plot/print.

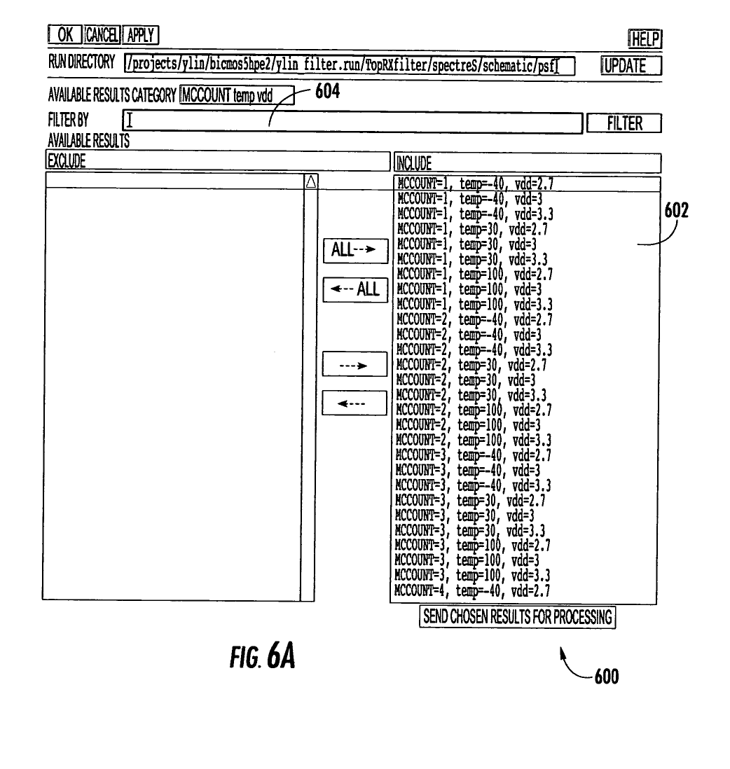

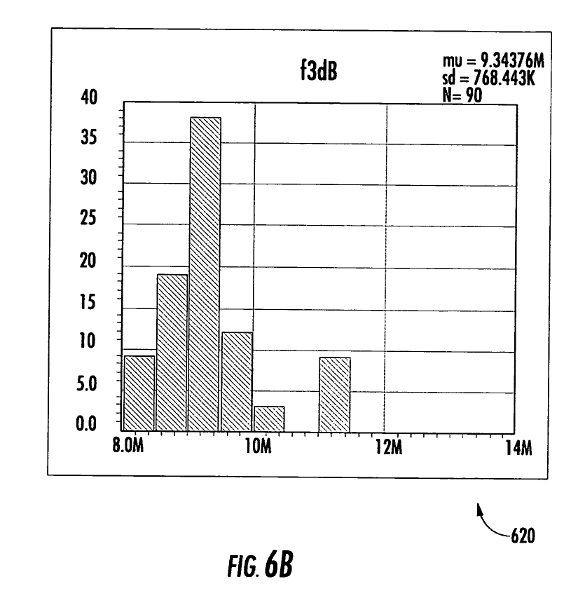

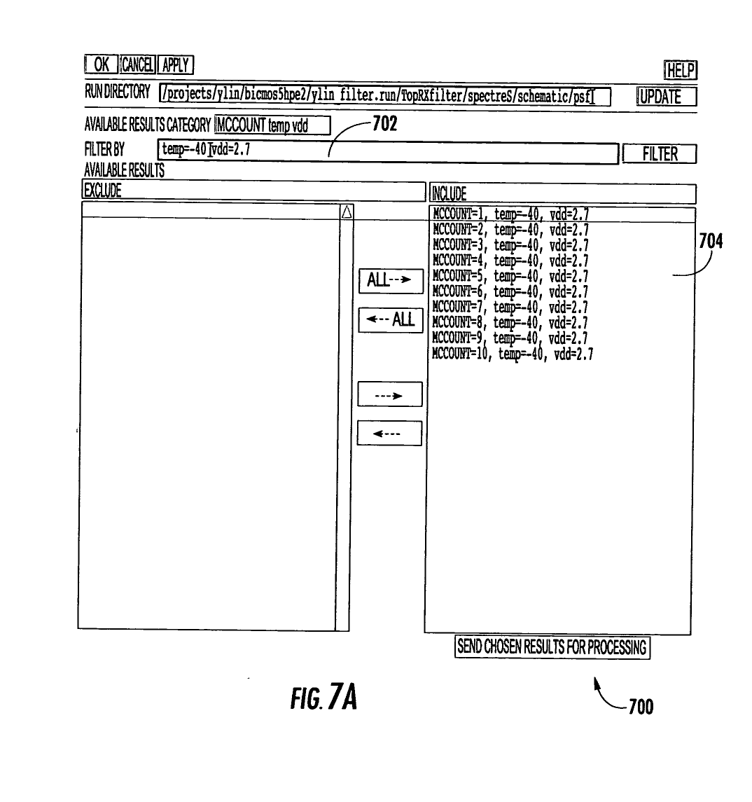

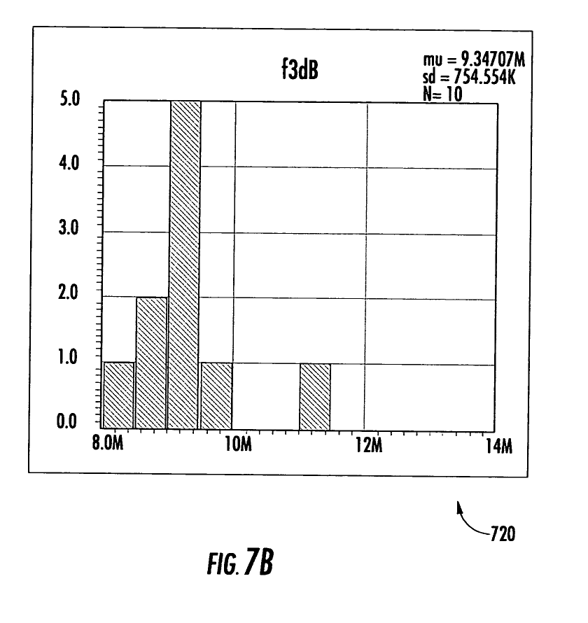

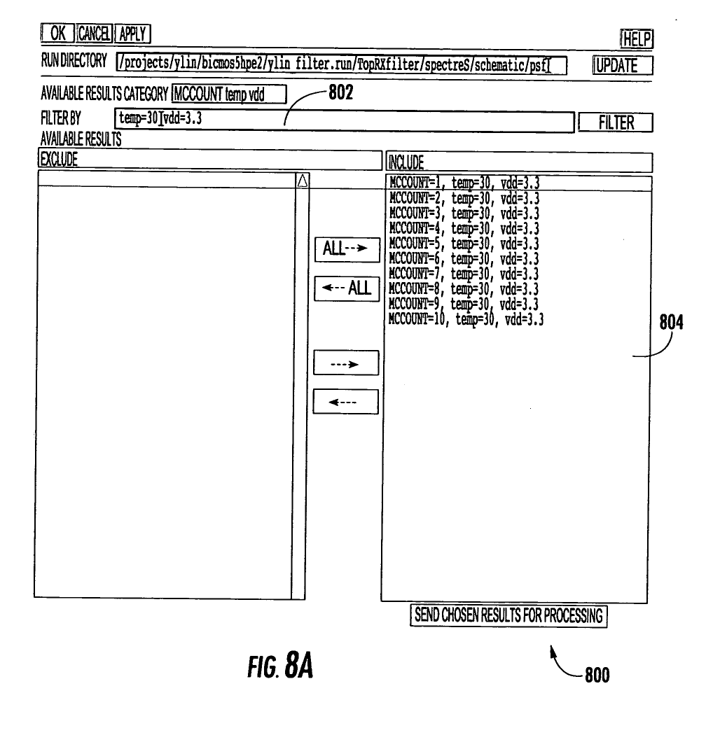

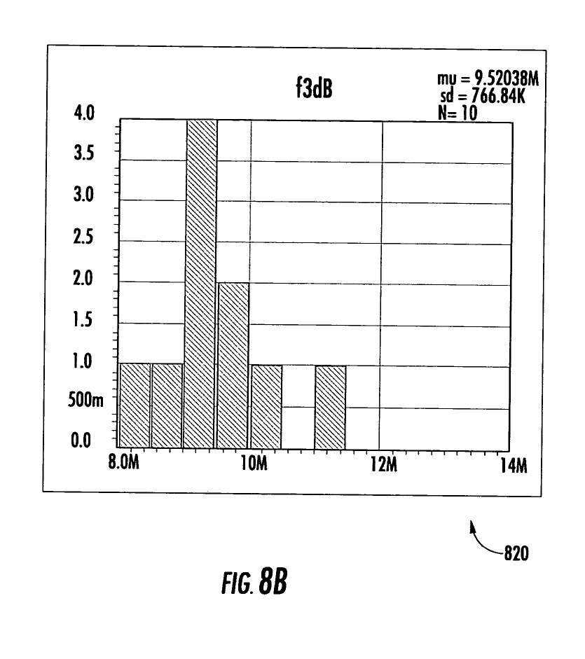

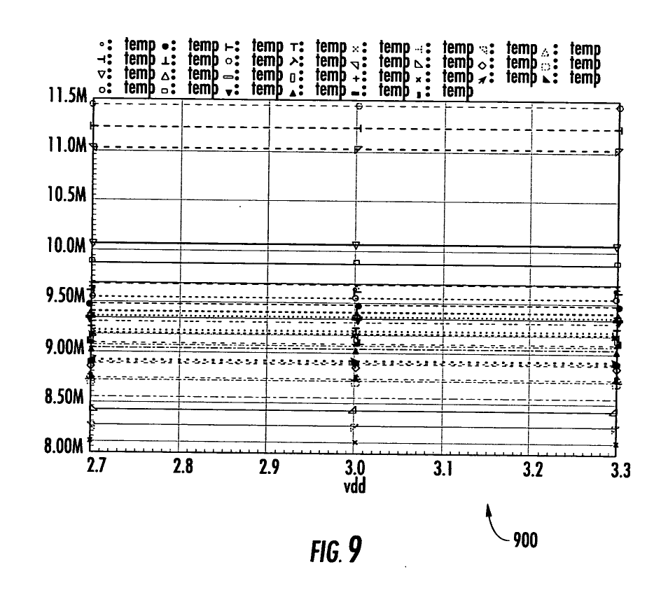

Referring to FIG. 6A, an example of a results filter GUI 600 including all results for a histogram calculator is illustrated. As illustrated, the filter by button 604 is blank and the include field 602 of the available results includes all results for the histogram calculator. FIG. 6B illustrates an example of a histogram 620 illustrating all the simulation results of the fast track result filter GUI 600 of FIG. 6A. An example of an embodiment implementing the filter by field 702 of a fast rack results filter GUI 700 is illustrated in FIG. 7A. As illustrated, the filter by field 702 of FIG. 7A includes the variables temp=40 and vdd=2.7. The result of the variables are displayed in the include field 704 of the available results. A histogram 720 illustrating the associated results of the variables temp=40 and vdd=2.7 is illustrated in FIG. 7B. For a further example, refer to the results filter GUI 800 of FIG. 8A. As illustrated the filter by field 802 includes the variables temp=30 and vdd=3.3. The associated results associated with these variables are displayed in the include field 804 of the available results. An associated histogram 820 that represents the variables temp=30 and vdd=3.3 is illustrated in FIG. 8B. An example of a plot of a family of curves 900 of one embodiment of the present invention is illustrated in FIG. 9.

Although specific embodiments have been illustrated and described herein, it will be appreciated by those of ordinary skill in the art that any arrangement, which is calculated to achieve the same purpose, may be substituted for the specific embodiment shown. For example, the above simulation is described as a Monti Carlo simulation, it will be understood in the art that any simulation using the technique of statistical sampling employed to approximate solutions to quantitative problems can be used and the present invention is not limited to Monte Carlo simulations. This application is intended to cover any adaptations or variations of the present invention. Therefore, it is manifestly intended that this invention be limited only by the claims and the equivalents thereof.

1. A method of evaluating circuit parameters of an integrated circuit design, the method comprising:
defining two or more variables to apply to the circuit parameters; and
running a simulation with the two or more variables on the circuit parameters.

2. The method of claim 1, further comprising:
building expressions to calculate circuit performance after running the simulation

3. The method of claim 1, further comprising:
selectively including and excluding parametric analysis results.

4. The method of claim 1, further comprising:
setting up variable sweep range; and
setting up variable step control.

5. The method of claim 1, wherein the simulation is a Monte Carlo simulation.

6. The method of claim 1, further comprising:
plotting results.

7. The method of claim 6, wherein the results are plotted into a histogram.

8. The method of claim 6, wherein the results are plotted into a family of curves.

9. The method of claim 6, further comprising:
printing the results.

10. A method of evaluating circuit parameters in an integrated circuit design, the method comprising:
defining a design variable to sweep;
running a simulation, wherein the simulation uses random numbers and probability statistics to obtain approximate results; and
building expressions to calculate circuit performance after running the simulation, wherein the errors in the expressions can be corrected without having to run another simulation.

11. The method of claim 10, further comprising:
defining one or more additional variables to sweep.

12. The method of claim 10, further comprising:
selecting results for processing.

13. The method of claim 10, wherein the simulation is a Monte Carlo simulation.

14. The method of claim 10, further comprising;
printing results.

15. The method of claim 10, further comprising;
evaluating expressions.

16. The method of claim 10, further comprising:
plotting results.

17. The method of claim 16, wherein plotting results further comprises:
plotting a histogram.

18. The method of claim 16, wherein plotting the results further comprises:
plotting a family of curves.

19. The method of claim 10, further comprising:
setting a sweep range.

20. The method of claim 19, further comprising:
setting a step control.

21. A computer-readable medium including instructions for simulating parameters in a circuit design comprising:
defining two or more variables to apply to the circuit parameters; and
running a simulation with the two or more variables on the circuit parameters.

22. The computer-readable medium of claim 21, further comprising:
building expressions to calculate circuit performance after running the simulation.

23. The computer-readable medium of claim 21, further comprising:
selectively including and excluding parametric analysis results.

24. The computer-readable medium of claim 21, further comprising:
setting up variable sweep range; and
setting up variable step control.

25. The computer-readable medium of claim 21, wherein the simulation is a Monte Carlo simulation.

26. The method of claim 21, further comprising:
plotting results.

27. The computer-readable medium of claim 26, wherein the results are plotted into a histogram.

28. The computer-readable medium of claim 26, wherein the results are plotted into a family of curves.

29. The computer-readable medium of claim 26, further comprising:
printing the results.
